(19) United States
(12) Patent Application Publication
(10) Pub. No.: US 2009/0262139 A1
(43) Pub. Date: Oct. 22, 2009

(54) VIDEO IMAGE DISPLAY DEVICE AND VIDEO IMAGE DISPLAY METHOD

(75) Inventors: Toshiyuki Tanaka, Osaka (JP); Sachiko Uranaka, Tokyo (JP); Seiya Miyazaki, Kanagawa (JP); Makoto Yasugi, Kanagawa (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/375,580

(22) PCT Filed: Jul. 27, 2007
(86) PCT No.: PCT/JP2007/064779

§ 371 Date: Jan. 29, 2009

(30) Foreign Application Priority Data
Aug. 2, 2006 (JP) 2006-211336

(51) Int. Cl. G09G 5/00; G06T 1/00; G06T 13/00

(52) U.S. Cl. 345/660; 345/418; 345/473

(57) ABSTRACT

A video image display device is provided to effectively display both basic and closed-up video images. This video image display device is comprised of a closed-up region determining unit (330) for discriminating a display region of a specific object in the basic video image to be subjected to display and for determining a display region of the closed-up video image in the basic video image in accordance with the display region of the specific object in the basic video image.

### TECHNICAL FIELD

The present invention relates to an image display apparatus and image display method that display computer graphics animation and suchlike images.

### BACKGROUND ART

In recent years, computer graphics animation (hereinafter referred to as “CG animation”) that provides appearing characters with detailed movements such as changes of expression have been attracting attention. Technologies have been described in Patent Document 1 and Patent Document 2, for example, that display close-up images of a specific object in order to make such image details easy to grasp.

In the technology described in Patent Document 1, display is switched between a basic image that is subject to display and a close-up image providing a close-up of a specific object such as a character in the basic image. This enables detailed movement such as a facial expression of a character to be grasped easily.

In the technology described in Patent Document 2, a close-up image is displayed in a previously prepared area separate from the display area of the basic image. This enables detailed movement of an object to be grasped easily.

### Patent Document 1: Japanese Patent Application Laid-Open No. 2003-323628

### Patent Document 2: Japanese Patent Application Laid-Open No. 2002-150317

### DISCLOSURE OF INVENTION

### Problems to be Solved by the Invention

However, a problem with the technology described in above Patent Document 1 is that the basic image is not displayed while a close-up image is being displayed. For example, if another character begins an action while a particular character is being displayed in close-up, the nature of that action cannot be displayed. Also, when only a specific region comprising a facial part of a character is subject to a close-up, if that character performs a whole-body action, the nature of that whole-body action cannot be displayed. That is to say, a problem with the technology described in Patent Document 1 is that a whole-body action, surrounding situation, or the like, of an object being displayed in close-up cannot be grasped.

Also, a problem with the technology described in above Patent Document 2 is that, since a basic image display area and a close-up image display area must both be placed on a limited screen prepared beforehand, the basic image display area becomes small. In particular, when display is performed on a small, low-resolution screen such as a liquid crystal panel of a mobile phone or PDA (personal digital assistants), it is difficult to grasp a whole-body action, surrounding situation, or the like, of an object itself that is being displayed in close-up. Improvements in the processing performance of various kinds of hardware and advances in computer graphics technology have led to widespread development of application software using CG animation images for small devices of this kind.

Therefore, it is desirable to be able to display both a basic image and a close-up image effectively even on a small, low-resolution screen.

It is an object of the present invention to provide an image display apparatus and image display method that enable both a basic image and a close-up image to be displayed more effectively.

### Means for Solving the Problems

An image display apparatus of the present invention employs a configuration having a display area discriminating section that discriminates a display area of a specific object in a basic image that is subject to display, and a close-up area determining section that determines a display area of a close-up image in the basic image according to the display area of the specific object in the basic image.

An image display method of the present invention has a display area discriminating step of discriminating a display area of a specific object in a basic image that is subject to display, and a close-up area determining step of determining a display area of a close-up image in the basic image according to the display area of the specific object in the basic image discriminated by the display area discriminating step.

### ADVANTAGEOUS EFFECT OF THE INVENTION

The present invention enables both a basic image and a close-up image to be displayed more effectively by determining a display area of the close-up image according to a display area of a specific object in the basic image.

### BRIEF DESCRIPTION OF DRAWINGS

FIG. 1 is a system configuration diagram showing the configuration of a CG animation display system as an image display apparatus according to an embodiment of the present invention;

FIG. 2 is an explanatory drawing showing: a sample description of an animation scenario in this embodiment;

FIG. 3 is a flowchart showing the flow of processing executed by a close-up area determining section in this embodiment;

FIG. 4 is an explanatory drawing showing the content of each item of processing executed by a close-up area determining section in this embodiment;

FIG. 5 is a flowchart showing the flow of processing executed in step S3000 in FIG. 3 in this embodiment;

FIG. 6 is an explanatory drawing showing an example of the content of an image when close-up display areas are changed in shape in this embodiment;

FIG. 7 is an explanatory drawing showing the nature of changes of a basic image that is subject to close-up display in this embodiment;

FIG. 8 is an explanatory drawing showing the nature of changes of object placement areas in this embodiment;

FIG. 9 is an explanatory drawing showing the nature of changes of close-up display areas in this embodiment;

FIG. 10 is an explanatory drawing showing the nature of changes of a final image in this embodiment;

FIG. 11 is an explanatory drawing showing an example of how the size and position of a close-up display area are interpolated by a smoothing interpolation determining section in this embodiment; and

FIG. 12 is an explanatory drawing showing another example of how the size and position of a close-up display area are interpolated by a smoothing interpolation determining section in this embodiment.

### BEST MODE FOR CARRYING OUT THE INVENTION

An embodiment of the present invention will now be described in detail with reference to the accompanying drawings.

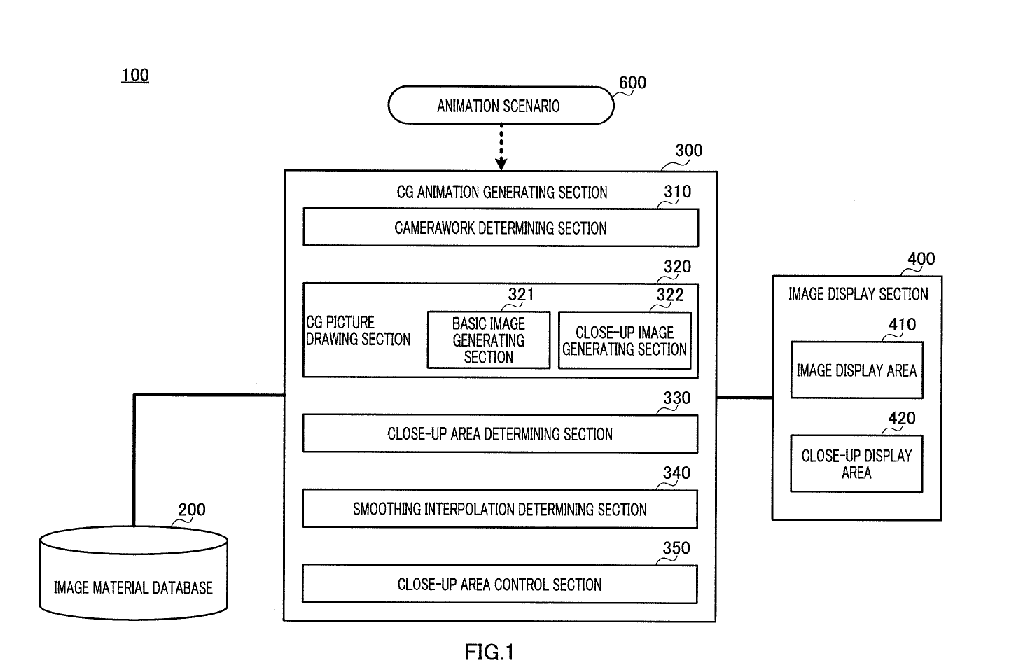

FIG. 1 is a system configuration diagram showing the configuration of a CG animation display system as an image display apparatus according to an embodiment of the present invention.

In FIG. 1, CG animation display system 100 has image material database 200, CG animation generating section 300, and image display section 400. CG animation generating section 300 has camerawork determining section 310, CG picture drawing section 320, close-up area determining section 330, smoothing interpolation determining section 340, and close-up area control section 350. CG picture drawing section 320 has basic image generating section 321 and close-up image generating section 322. Image display section 400 has image display area 410 and close-up display area 420. CG animation display system 100 inputs animation scenario 600, which is the basis of CG animation, as input.

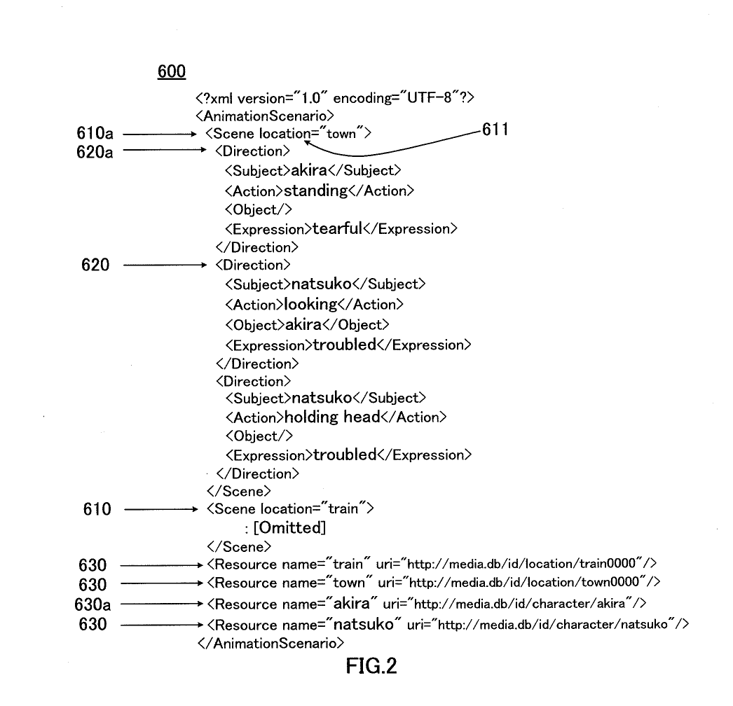

FIG. 2 is an explanatory drawing showing a sample description of animation scenario 600. Animation scenario 600 is like the script or scenario of a motion picture or play. Animation scenario 600 contains a number of “Scenes” 610. Each “Scene” 610 has attribute “location” 611 indicating a background set. Also, each “Scene” 610 has a plurality of “Directions” 620 as sub-elements. Information such as “Subject”, “Action”, and “Object” is written under each “Direction” 620. Also, if a subject is a character, additional information such as “Expression” is written under “Direction” 620.

Animation scenario 600 also contains “Resource (resource information)” 630. “Resource (resource information)” 630 shows association between a name written in “Scene” 610 and image material necessary for display as a CG animation image. Specifically, each “Resource” 630 has an attribute “uri” indicating an identifier of image material, and an attribute “name” indicating a name written in “Scene” 610, “Subject”, or the like. For example, under “Direction” 620a of “Scene” 610a, character name “akira” is written as a subject. And in “Resource” 630a, image material identifier “http://media.db/id/character/akira” is written associated with the name “akira”.

Image material database 200 shown in FIG. 1 stores image material necessary for generating CG animation. Image material includes at least 3D (dimension) model data indicating the shape or external appearance of various kinds of objects such as characters and background sets. Image material also includes motion data, still-image data, moving-image data, audio data, music data, and so forth. Motion data indicates motion of 3D model data. Still-image data and moving-image data are used in 3D model data texture, background, or suchlike drawing. Audio data is used in the output of sound effects, synthetic speech, and so forth. Music data is used in the output of BGM (background music) or the like.

CG animation generating section 300 acquires necessary image material from image material database 200, and generates CG animation of content in line with animation scenario 600.

CG animation generating section 300 causes image display section 400 to display a basic image of generated CG animation and a close-up image of an object that appears in generated CG animation.

In CG animation generating section 300, camerawork determining section 310 determines a position of an object such as a character, background set, or the like, in an animation space, based on an animation scenario 600 description. Then camerawork determining section 310 determines camerawork for shooting an object whose position has been determined. Specifically, for example, camerawork determining section 310 places a camera at a predetermined position of the animation space and determines basic camerawork. Alternatively, camerawork determining section 310 determines basic camerawork so that shooting is performed with reference to a specific object. Technology for determining CG animation camerawork from an animation scenario is known, being described in Japanese Patent Application Laid-Open No. 2005-44181, for example, and therefore a description thereof is omitted here.

Also, in a scene in which a character appears in a basic image, camerawork determining section 310 determines camerawork for shooting a facial part of the character together with basic camerawork. Then camerawork determining section 310 generates data in which determined object positions and camerawork contents are converted to parameters internally by means of coordinate data and so forth, and outputs the generated data to CG picture drawing section 320.

CG picture drawing section 320 acquires image material necessary for drawing from image material database 200 based on the data input from camerawork determining section 310 and the animation scenario 600 description, and generates a CG animation image. Specifically, CG picture drawing section 320 first acquires image material from image material database 200 in accordance with the animation scenario 600 description, and then places each acquired image material at a position determined by camerawork determining section 310.

For example, when the description content of “Direction” 620a of animation scenario 600 is converted to CG animation, CG picture drawing section 320 acquires image material corresponding to identifier “http://media.db/id/character/akira” from image material database 200, and then places the acquired image material as a subject.

When placing each acquired image material, CG picture drawing section 320 generates an image implementing camerawork determined by camerawork determining section 310. Then CG picture drawing section 320 causes image display section 400 to draw the generated image. Specifically, in CG picture drawing section 320, basic image generating section 321 generates a basic image based on basic camerawork, and outputs the generated basic image to close-up area determining section 330 and image display section 400. Also, close-up image generating section 322 generates a close-up image based on close-up camerawork, and outputs the generated close-up image to image display section 400.

Since each material is a computer graphic, it is easy to recognize what kind of image is displayed in what part of image display area 410 when a basic image is drawn in image display area 410 of image display section 400. Close-up area determining section 330 determines the size and position of close-up display area 420. Then close-up area determining section 330 outputs information indicating the size and position of the determined close-up display area 420 to image display section 400 and smoothing interpolation determining section 340. Close-up area determining section 330 analyzes the basic image input from CG picture drawing section 320 and discriminates an area other than a display area of an object to be displayed with priority from within image display area 410. Then close-up area determining section 330 determines close-up display area 420 in an area determined to be an area other than a display area of an object to be displayed with priority. It goes without saying that this kind of close-up area determining section 330 function is unnecessary if image display area 410 and close-up display area 420 are prepared in advance as separate display areas, as in the technology described in Patent Document 1 above.

Smoothing interpolation determining section 340 analyzes a change of close-up display area 420 based on information input from close-up area determining section 330. Then smoothing interpolation determining section 340 interpolates the analyzed close-up display area 420 change, and provides for the close-up display area 420 change to be performed smoothly or naturally.

Close-up area control section 350 determines whether or not a close-up image generated by close-up image generating section 322 is to be displayed by image display section 400.

Image display section 400 has a liquid crystal panel or suchlike display screen (not shown), and places image display area 410, which is an area for displaying a CG animation basic image, in the display screen. Also, image display section 400 places close-up display area 420, which is an area for displaying a CG animation close-up image, in the display screen. Then image display section 400 draws a basic image input from CG animation generating section 300 in image display area 410, and also draws a close-up image input from CG animation generating section 300 in close-up display area 420. The size, position, and display/non-display of close-up display area 420 are controlled by information input from CG animation generating section 300.

Although not shown in the drawings, CG animation display system 100 comprises a CPU (Central Processing Unit), a storage medium such as ROM (Read Only Memory) that stores a control program, and RAM (Random Access Memory) or suchlike working memory. The functions of the above sections are implemented by the CPU executing the control program.

Image material database 200, image display area 410, and close-up display area 420 may each be connected directly to CG animation generating section 300 via a bus, or may be connected to CG animation generating section 300 via a network.

The operation of close-up area determining section 330 will now be described in detail.

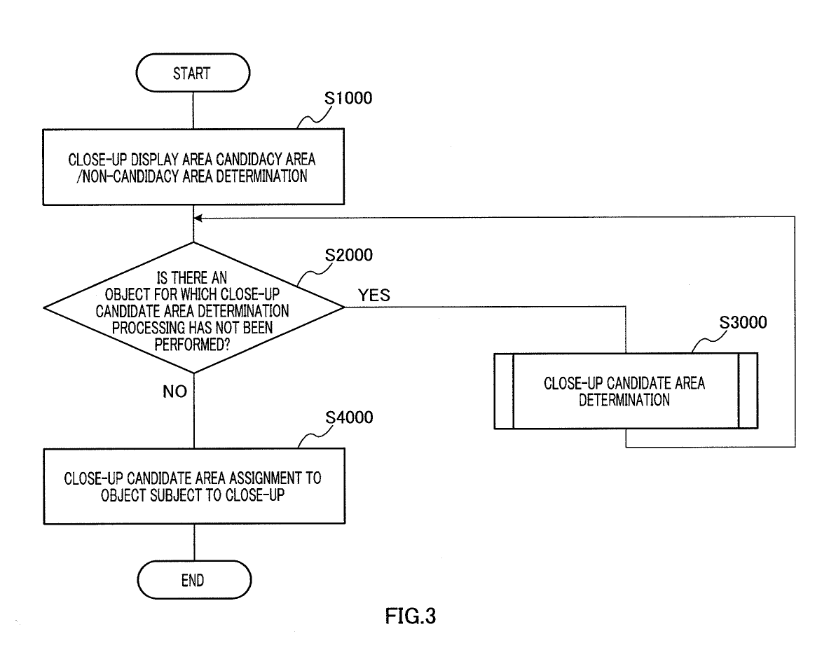

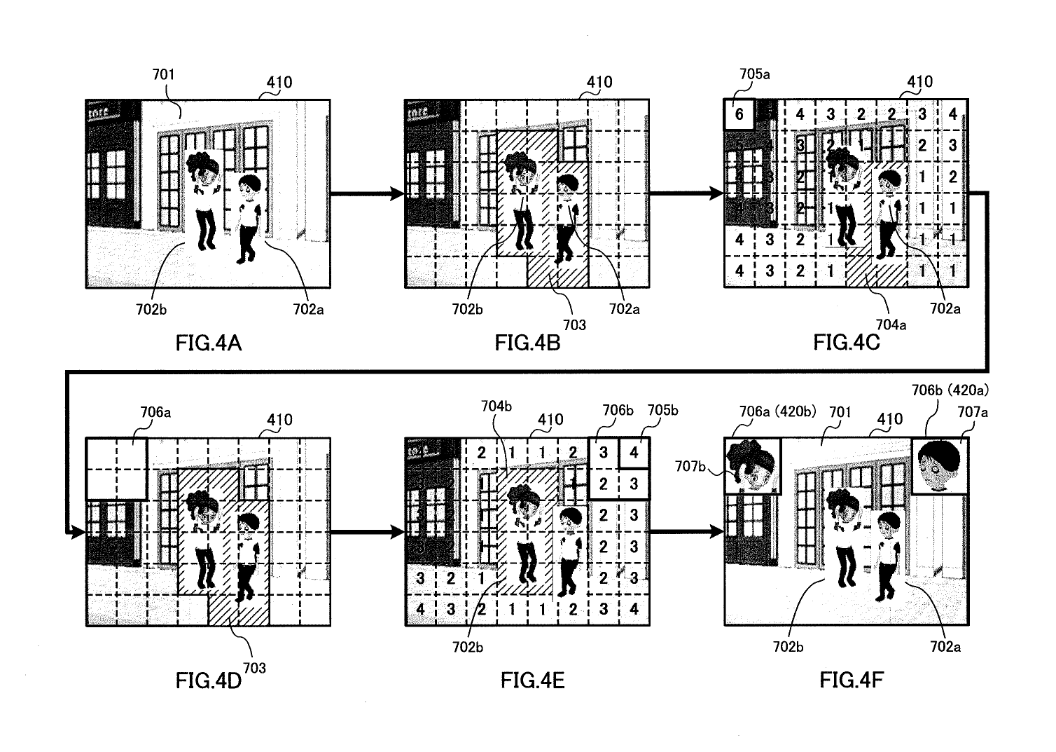

FIG. 3 is a flowchart showing the flow of processing executed by close-up area determining section 330, and FIG. 4 shows the content of each item of processing executed by close-up area determining section 330, taking a basic image of a particular moment (hereinafter referred to simply as “basic image”) as an example. The operation of close-up area determining section 330 will be described here with reference to FIG. 3 and FIG. 4.

In step S1000 in FIG. 3, close-up area determining section 330 picks up an object to be displayed with priority, such as a character, from a basic image. Then close-up area determining section 330 classifies image display area 410 into a candidacy area and non-candidacy area. A candidacy area is an area that is treated as a close-up display area 420 candidate. A non-candidacy area is an area that is not treated as a close-up display area 420 candidate. It is assumed here that an object that is subject to a close-up is an object to be displayed with priority.

As shown in FIG. 4A, basic image 701 in which character “akira” 702a and character “natsuko” 702b are placed is generated by basic image generating section 321 of CG picture drawing section 320 based on animation scenario 600. In this case, close-up area determining section 330 picks up character “akira” 702a and character “natsuko” 702b.

Then, as shown in FIG. 4B, close-up area determining section 330 divides image display area 410 in which basic image 701 is displayed into N×M areas (where N and M are natural numbers), and determines for each division area whether or not a display area of a picked up character is present. Then close-up area determining section 330 determines a division area in which a character display area is not present within image display area 410 to be a close-up display area 420 candidacy area. Also, close-up area determining section 330 determines a division area in which a character display area is present to be close-up display area 420 non-candidacy area 703 (the hatched area in the figure).

In FIG. 4, image display area 410 is divided into 48 rectangles, eight horizontally and six vertically, but the direction, number, and shape of the divisions are not limited to this case. For example, processing may be performed in dot units, with only an area enclosed by the outline of a character being taken to be a non-candidacy area.

Next, in step S2000 in FIG. 3, close-up area determining section 330 determines whether or not an object for which close-up candidate area determination processing has not been performed remains among objects that are subject to a close-up (objects to be displayed with priority). A close-up candidate area is an area that may become close-up display area 420 described later herein. If an object that is subject to a close-up remains (S2000: YES), close-up area determining section 330 proceeds to step S3000 processing. If an object that is subject to a close-up does not remain (S2000: NO), close-up area determining section 330 proceeds to step S4000 processing.

In step S3000, close-up area determining section 330 selects one object that is subject to a close-up, and determines a close-up candidate area based on the selected object. Here, a case in which a close-up candidate area is determined based on character “akira” 702a will first be described as an example.

When there are a plurality of objects that are subject to a close-up, the selection order may be the order of appearance in animation scenario 600, for example. Alternatively, a degree of importance may be set in advance for each object and the order selected according to the degree of importance, or selection may be performed randomly each time.

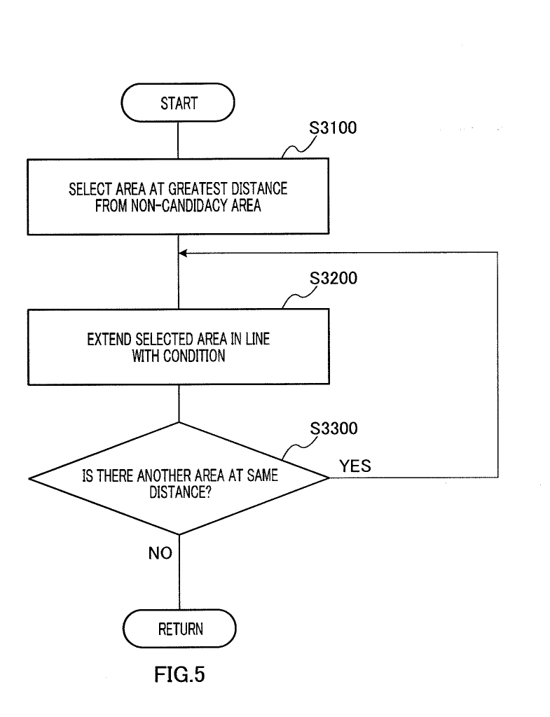

FIG. 5 is a flowchart showing the flow of processing executed in step S3000 in FIG. 3.

In step S3100, close-up area determining section 330 discriminates a division area 704 in which a display area of an object (hereinafter referred to as an “object placement area”) deemed to be subject to processing is present. Then close-up area determining section 330 selects a division area positioned at the greatest distance from discriminated object placement area 704 among the division areas of image display area 410. Calculation of a division area positioned at the greatest distance may be performed using simple linear distance, or by applying weights in specific directions, such as the vertical and horizontal directions.

Alternatively, calculation of a division area positioned at the greatest distance may be performed by taking the distance between adjacent division areas as “1”, taking only the vertical and horizontal directions as measurement directions, and calculating a numeric value indicating the distance of each division area from object placement area 704. In this case, close-up area determining section 330 may take a division area with the highest numeric value as an area positioned at the greatest distance from object placement area 704. Calculating numeric values indicating distances from object placement area 704a of character “akira” 702a for each division area in FIG. 4B using this method, and displaying the calculation results in the division areas, gives the result shown in FIG. 4C.

Here, as shown in FIG. 4C, the numeric value of division area 705a in the top-left corner of image display area 410 is the highest. Therefore, division area 705a is selected as a division area to be used as a close-up candidate area reference (hereinafter referred to as “candidate reference area”). This candidate reference area need not necessarily be an area positioned at the greatest distance from object placement area 704, as long as it is an area other than object placement area 704.

Next, in step S3200 in FIG. 5, close-up area determining section 330 extends the single division area selected as a candidate reference area in accordance with a predetermined condition, and selects the post-extension area as a close-up candidate area.

For example, the condition “2 division areas vertically×2 division areas horizontally and not including non-candidacy area 703” may be set as a condition for a post-extension area. In this case, when character “akira” 702a is an object that is subject to processing, extension area 706a comprising four division areas in the top-left corner of image display area 410 is selected as a close-up candidate area, as shown in FIG. 4D. Another example of a post-extension area condition that may be used is “the maximum area with the same number of division areas vertically and horizontally and not including non-candidacy area 703”.

Next, in step S3300 in FIG. 5, close-up area determining section 330 determines whether or not another division area that has not been subjected to processing in step S3200 is present in a division area at the greatest distance from an object placement area. That is to say, close-up area determining section 330 determines whether or not a division area positioned at the same distance from an object placement area as a division area already subjected to step S3200 processing is present. If a corresponding division area is present (S3300: YES), close-up area determining section 330 returns to step S3200 and performs close-up candidate area selection based on the relevant division area. If a corresponding division area is not present (S3300: NO), close-up area determining section 330 terminates the series of processing steps.

Here, as shown in FIG. 4C, there is only one division area with the highest numeric value (S3300: NO), and therefore close-up area determining section 330 terminates processing after selecting one close-up candidate area.

When the processing in step S3000 in FIG. 3 is completed in this way, close-up area determining section 330 returns to step S2000 in FIG. 3. Here, character “natsuko” 702b still remains as an object that has not been subjected to close-up candidate area determination processing among objects that are subject to a close-up (S2000: YES). Therefore, close-up area determining section 330 proceeds to step S3000 processing again. Close-up area determining section 330 then executes the series of processing steps shown in FIG. 5, this time with character “natsuko” 702b as the object that is subject to processing.

Calculating numeric values indicating distances from object placement area 704b of character “natsuko” 702b and displaying the calculation results in the division areas, in the same way as in the processing to which character “akira” 702a was subjected, gives the result shown in FIG. 4E. Here, as shown in FIG. 4E, the numeric values of the four division areas in the four corners of image display area 410 are the highest.

Therefore, division areas in the four corners, including division area 705b positioned in the top-right corner of image display area 410, are selected as candidate reference areas, and extension areas in the four corners including extension area 706b positioned in the top-right corner of image display area 410 are selected as close-up candidate areas.

When close-up candidate area determination processing is performed in this way for all objects that are subject to a close-up (S2000: NO), close-up area determining section 330 proceeds to step S4000 processing.

In step S4000, close-up area determining section 330 assigns a determined close-up candidate area as close-up display area 420 to each object that is subject to close-up display.

For example, in the case of basic image 701 shown in FIG. 4, as described above, extension areas in the four corners of image display area 410 are determined to be close-up candidate areas. It is assumed here that a rule for close-up display area 420 assignment—for example, “prioritize assignment of an upper close-up candidate area, and assign in order from the close-up candidate area candidate at the shortest distance”—has been set in advance.

When the distances from each character 702 are compared for the upper two of the extension areas positioned in the four corners of image display area 410, the shortest distance is that from character “akira” 702a to extension area 706b. Therefore, close-up area determining section 330 first assigns extension area 706b to close-up display area 420a of character “akira” 702a, and then assigns remaining extension area 706a to close-up display area 420b of character “natsuko” 702b, as shown in FIG. 4F.

The rule “prioritize assignment of the nearest close-up candidate area to the close-up candidate area assigned immediately before” may be set in advance as a rule for close-up display area 420 assignment. By applying such a rule, it is possible to keep movement of close-up display area 420 of the same character 702 to a minimum.

After determining all necessary close-up display areas 420 in this way, close-up area determining section 330 terminates the series of processing steps.

Close-up area control section 350 determines sequentially whether or not close-up display area 420 determined by close-up area determining section 330 should be displayed. Then close-up area determining section 330 controls display/non-display of close-up display area 420 according to the result of the determination as to whether or not close-up display area 420 should be displayed.

For example, close-up area determining section 330 may perform control so that close-up display area 420 is displayed only if close-up display area 420 determined by close-up area determining section 330 can secure at least a predetermined area. Alternatively, close-up area determining section 330 may control display of corresponding close-up display area 420 in synchronization with an action of character 702. To be more specific, close-up area determining section 330 controls in such a manner that corresponding close-up display area 420 is displayed only when character 702 speaks or only in a fixed section in which the expression of character 702 changes. By this means it is possible to cut down on close-up displays that have little effect, and to reduce the screen complexity and apparatus load.

Close-up area determining section 330 discriminates a section in which character 702 is speaking or a section in which the expression of character 702 changes, for example, from an animation scenario 600 description. Specifically, for example, close-up area determining section 330 identifies a section corresponding to “Direction” 620 under which “Expression” is written, and determines a section extending for only a few seconds before and after that section to be a section in which the expression of character 702 changes.

When close-up display areas 420 are displayed by means of the above-described processing, close-up image 707a of character “akira” 702a is displayed at the top-right of basic image 701, and close-up image 707b of character “natsuko” 702b is displayed at the top-left of basic image 701, as shown in FIG. 4F.

As can also be seen from FIG. 4F, as a result of processing by close-up area determining section 330, close-up images 707 are both displayed in positions that do not overlap characters 702. That is to say, both the whole body and the facial part of each character 702 are displayed. Also, character 702 whole-body actions and facial expressions are displayed efficiently, and an expressive image is implemented. Furthermore, since close-up images 707 are displayed within image display area 410, the size of the display area of basic image 701 and the whole-body display size of each character 702 are unaltered.

After determining division area 705 and extension area 706, close-up area determining section 330 may change the shape of a close-up display area to other than a rectangle.

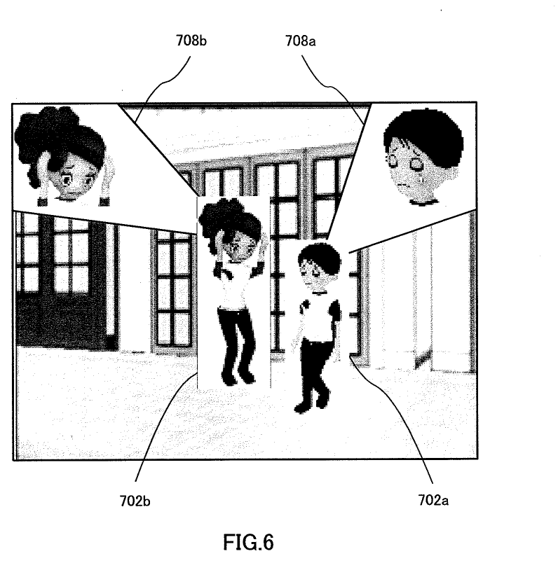

FIG. 6 is an explanatory drawing showing an example of an image when close-up display areas are changed in shape. A case is shown here in which a change of shape is applied to rectangular close-up display areas so that the vertex nearest the center point of a close-up of corresponding character 702 is moved to that center point. However, provision is made for objects to be displayed in front of close-up display areas 708 that have been changed in shape. Close-up display areas 708 that have been changed in shape in this way make it easier to understand which object a close-up relates to.

After determination or change of shape of close-up display area 420, provision may be made for new close-up camerawork to be determined again by camerawork determining section 310. Alternatively, provision may be made for the actual determination of close-up camerawork to be performed after close-up display area 420 determination.

In FIG. 4 and FIG. 6, a case has been illustrated in which the shooting direction of a close-up image is the same the shooting direction of a basic image, but the present invention is not limited to this. For example, provision may be made for close-up camerawork to be determined so that a character is always shot full-face. This enables the expression of a character to be displayed even if the character is facing rearward in a basic image, for example.

In the above description, as stated in the explanation of step S1000 in FIG. 3, an object that is subject to a close-up has been assumed to be an object to be displayed with priority, but objects that are subject to a close-up may also be assumed to be all or some objects to be displayed with priority. In this case, in step S1000 in FIG. 3, close-up area determining section 330 uses an object to be displayed with priority for determination of classification as a candidacy area or non-candidacy area, and in step S3000 in FIG. 3, close-up are a determining section 330 uses objects that are subject to a close-up that are all or some of objects to be displayed with priority for close-up candidate area determination.

Various rules can be applied to differentiation between an object that is subject to a close-up and an object that is not subject to a close-up. For example, a rule may be applied to the effect that an item for which “Expression” is defined among “Directions” 620 shown in FIG. 2 is made subject to a close-up. Also, for example, a rule may be applied to the effect that when an attribute indicating whether or not the relevant object is the target is defined in “Resource (resource information)” 630 shown in FIG. 2, that item is made subject to a close-up.

An attribute indicating whether or not an object is a person, for example, may be used as an attribute indicating whether or not an object is subject to a close-up. An attribute indicating whether or not an object is a person may be designated “attr”, for example, and indicate whether or not an object is a person according to whether or not “person” has been set. In this case, “Resource name=“akira” attr=person uri= . . . ”, for example, is written as “Resource (resource information)” 630 in animation scenario 600. Also, “Resource name=“chair” attr=chair uri= . . . ”, for example, is written as “Resource (resource information)” 630 in animation scenario 600. From these “Resource (resource information)” 630 items, it can be seen that the object “akira” is a person and the object “chair” is not a person.

By this means, close-up area determining section 330 can ensure priority display while providing for a close-up not be performed for a character for which a change of expression cannot be conveyed or non-human object, in particular.

Also, if there are too many objects that are subject to a close-up compared with candidacy areas, provision may be made for close-up area determining section 330 to reduce the number of objects that are subject to a close-up. For example, close-up area determining section 330 may determine a priority for each object according to whether or not there is an “Expression” definition or whether or not the object is a human object. Then close-up area determining section 330 determines objects that are subject to a close-up in order starting with a high-priority object through linkage with a candidacy area. By this means, for example, in a scene in which objects are placed discretely, there are fewer objects that are subject to a close-up due to the fact that the candidacy area is smaller, and conversely, in a scene in which objects are placed densely, there are more objects that are subject to a close-up due to the fact that the candidacy area is larger. That is to say, different close-up display effects can be obtained according to the circumstances of a scene.

The way in which CG animation display system 100 displays an image has been described above for a basic image of a particular moment. However, a display area of an object normally changes from moment to moment in a basic image generated based on an animation scenario. Therefore, close-up area determining section 330 dynamically performs the above-described close-up display area 420 determination processing each time the display area of an object changes. Alternatively, close-up area determining section 330 dynamically performs the above-described close-up display area 420 determination processing in sufficiently short cycles (such as 15 times a second) compared with the speed of change of the display area of an object.

The way in which close-up display area 420 changes according to changes in the display area of an object in a basic image is described below, taking one example of basic image change.

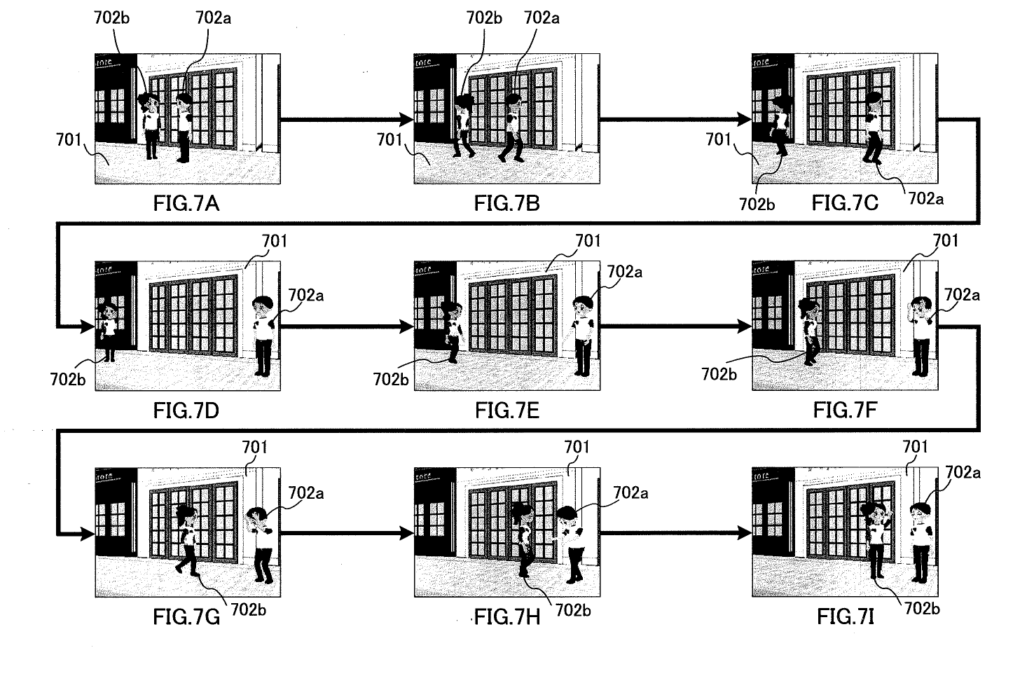

FIG. 7 is an explanatory drawing showing the nature of changes of a basic image that is subject to close-up display. Here, each basic image at the time when close-up display area 420 determination processing is performed nine consecutive times by close-up area determining section 330 is illustrated in a time sequence. Below, an animation time subject to close-up display area 420 determination processing by close-up area determining section 330 is referred to as an area determination time.

As shown in FIG. 7A through FIG. 7I, character “akira” 702a and character “natsuko” 702b appear in basic image 701. The display area of each character 702 changes over time in line with movement in the animation space of each character 702.

Close-up area determining section 330 discriminates object placement area 704 in the basic image for each object that is subject to close-up display.

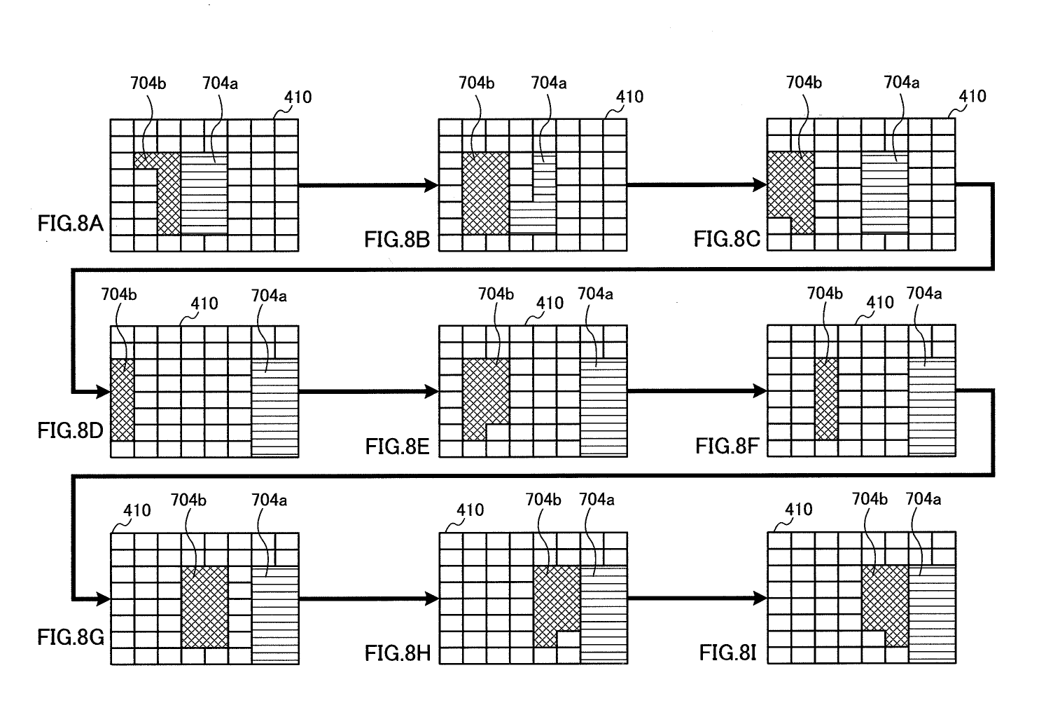

FIG. 8 is an explanatory drawing showing the nature of changes of object placement areas 704. FIG. 8A through FIG. 8I correspond to FIG. 7A through FIG. 7I respectively.

Close-up area determining section 330 divides image display area 410, and here, object placement area 704a of character “akira” 702a and object placement area 704b of character “natsuko” 702b are discriminated for each basic image 701 as shown in FIG. 7A through FIG. 7I.

As shown in FIG. 8, each object placement area 704 also changes over time. An area including object placement area 704a of character “akira” 702a and object placement area 704b of character “natsuko” 702b becomes non-candidacy area 703.

Close-up area determining section 330 determines close-up display areas 420 within image display area 410 so as not to overlap non-candidacy area 703.

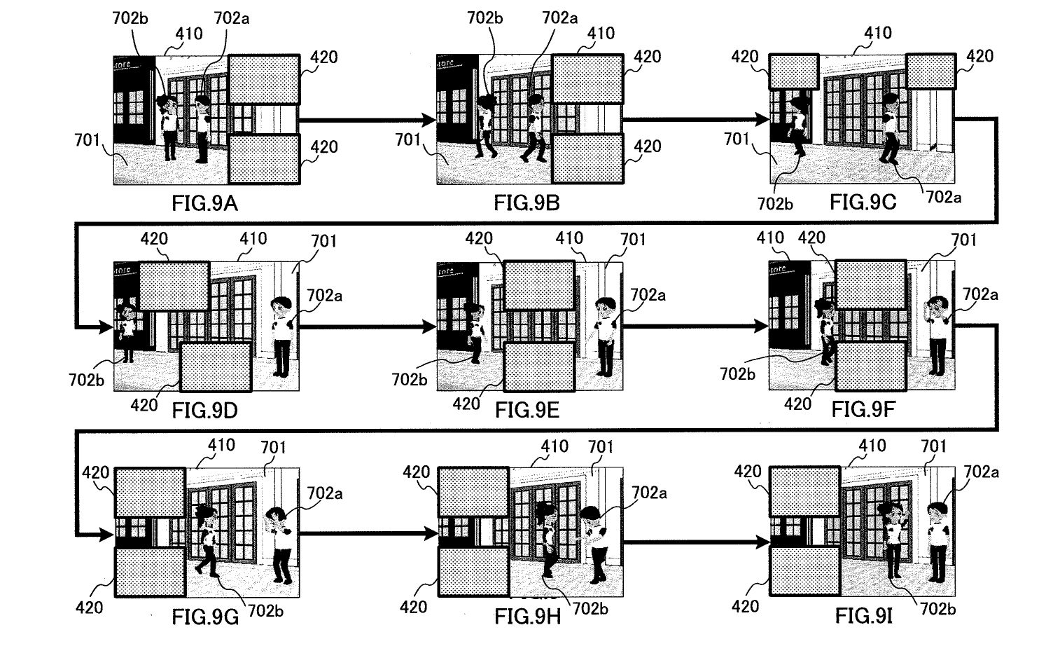

FIG. 9 is an explanatory drawing showing the nature of changes of close-up display areas 420. FIG. 9A through FIG. 9I correspond to FIG. 7A through FIG. 7I and FIG. 8A through FIG. 8I respectively.

Within image display area 410, close-up area determining section 330 determines areas that are areas other than non-candidacy area 703 (candidacy areas) and that satisfy a preset condition to be close-up display areas 420. Here, a case is illustrated in which image display area 410 is divided into 64 rectangles, eight horizontally and eight vertically, and “the maximum area with the same number of division areas vertically and horizontally and not exceeding 3 division areas vertically×3 division areas horizontally” has been set as a close-up candidate area condition.

As shown in FIG. 9, close-up display areas 420 also change over time, but never overlap a character 702 display area.

Close-up area determining section 330 assigns close-up display areas 420 to objects that are subject to close-up display in accordance with the preset condition. CG picture drawing section 320 causes a final CG animation image (hereinafter referred to as “final image”) to be displayed by causing the relevant close-up image 707 to be displayed in each close-up display area 420 in accordance with this assignment.

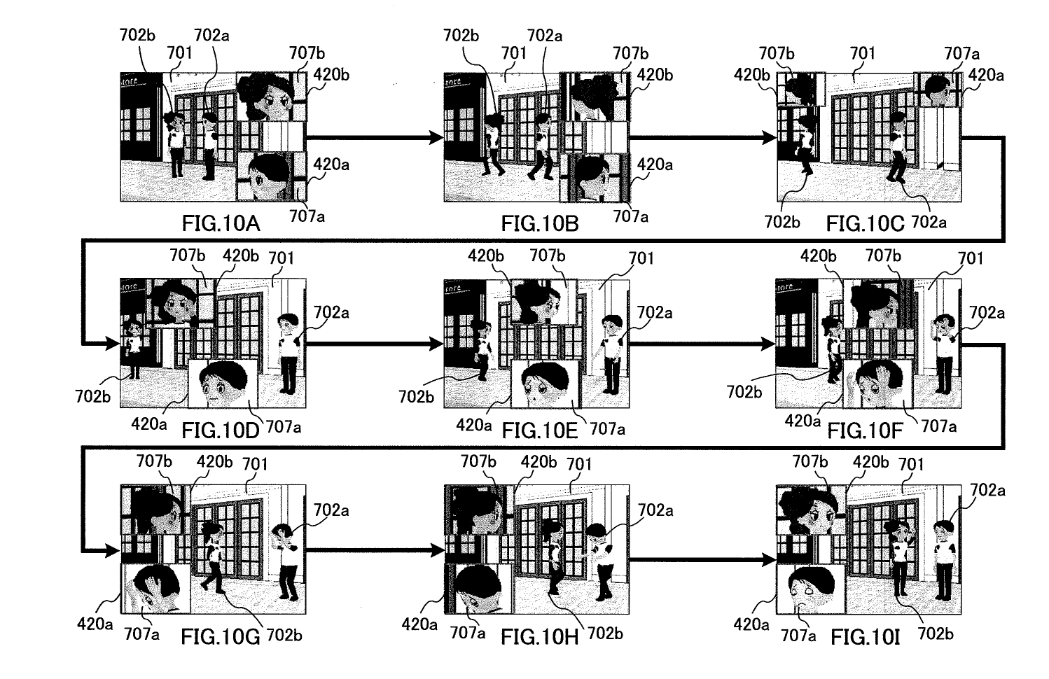

FIG. 10 is an explanatory drawing showing the nature of changes of a final image. FIG. 10A through FIG. 10I correspond to FIG. 9A through FIG. 9I respectively.

CG picture drawing section 320 causes close-up image 707 of each object that is subject to close-up display to be displayed in the assigned close-up display area 420. By this means, close-up images 707 are displayed embedded in basic image 701 without interfering with the display of characters 702, as shown in FIG. 10.

As shown in FIG. 9C and FIG. 10C, close-up display areas 420 may temporarily become smaller due to the relationship between a condition and a candidacy area when determining a close-up candidate area, as described above. Also, as shown in FIG. 10A through FIG. 10I, the position of close-up display area 420 for a particular character differs according to the area determination time. If such switching of the size and position of close-up display area 420 is performed discretely only at each area determination time, there is a possibility of the final image appearing unnatural and jerky.

Thus, smoothing interpolation determining section 340 interpolates the size and position of close-up display area 420 in a section between area determination times so that the size and position of close-up display area 420 change progressively or naturally.

At each area determination time, smoothing interpolation determining section 340 acquires size and position information of close-up display area 420 determined by close-up area determining section 330. Then smoothing interpolation determining section 340 determines whether or not there is a close-up display area 420 change between adjacent area determination times. If there is a change, smoothing interpolation determining section 340 determines the implementation method of the close-up display area 420 change in a section between preceding and succeeding area determination times in accordance with a preset rule, and performs close-up display area 420 change smoothing processing.

Smoothing interpolation determining section 340 may, for example, apply the rule “if close-up display areas 420 overlap between preceding and succeeding area determination times, change the close-up display area 420 outline progressively” as a rule for determining the close-up display area 420 change implementation method. Alternatively, smoothing interpolation determining section 340 may, for example, apply the rule “if close-up display areas 420 do not overlap between preceding and succeeding area determination times, and there is a candidacy area enabling close-up display area 420 to be moved progressively, move close-up display area 420 progressively”. As a further example, smoothing interpolation determining section 340 may apply the rule “if close-up display areas 420 do not overlap between preceding and succeeding area determination times, and there is not a candidacy area enabling close-up display area 420 to be moved progressively, temporarily reduce the size of close-up display area 420 until it disappears, and then enlarge it to its original size after changing its position”.

Determination of the size and position of close-up display area 420 in a section between area determination times may be performed by smoothing interpolation determining section 340. Alternatively, smoothing interpolation determining section 340 may output a determined smoothing change implementation method to close-up area determining section 330, after which the size and position of the above-described close-up display area 420 is determined by close-up area determining section 330. Information indicating the size and position of the close-up display area 420 in the determined section between area determination times is output to image display section 400.

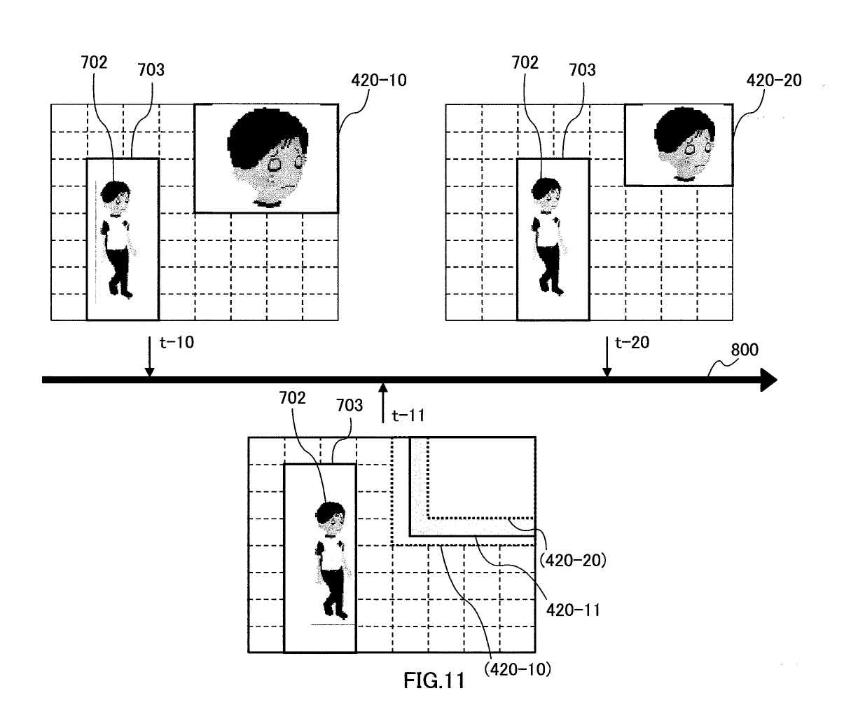

FIG. 11 is an explanatory drawing showing an example of how the size and position of close-up display area 420 are interpolated by smoothing interpolation determining section 340. Horizontal axis 800 indicates animation times. The area above horizontal axis 800 relates to an explanation concerning area determination times, and the area below horizontal axis 800 relates to an explanation concerning a section between area determination times.

As shown in FIG. 11, when character 702 moves between time t-10, which is an area determination time, and time t-20, which is the next area determination time, non-candidacy area 703 also moves. Close-up display areas 420-10 and 420-20 are deemed to be determined respectively for times t-10 and t-20 as a result. Also, as shown in FIG. 11, these close-up display areas 420-10 and 420-20 are deemed to be overlapping areas even though they are different in size.

When an above rule is applied, smoothing interpolation determining section 340 progressively changes the outline of close-up display area 420 between times t-10 and t-20. As a result, as shown in FIG. 11, at time t-11 between times t-10 and t-20, for example, interpolation is performed using close-up display area 420-11 of a size between close-up display areas 420-10 and 420-20. In this way, the size of close-up display area 420 changes smoothly.

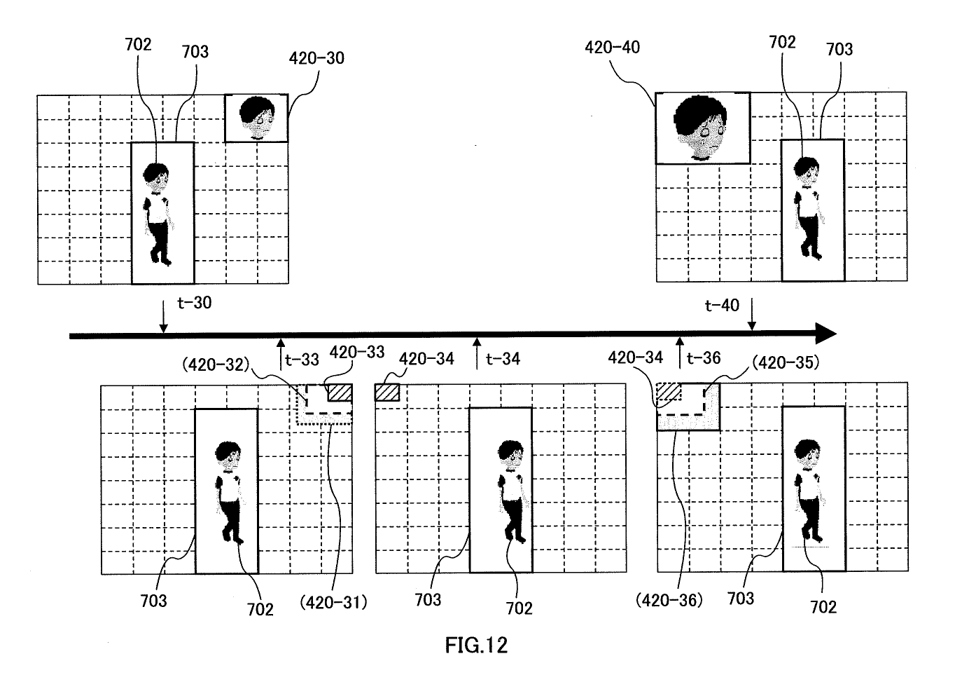

FIG. 12 is an explanatory drawing showing another example of how the size and position of close-up display area 420 are interpolated by smoothing interpolation determining section 340, corresponding to FIG. 11. As shown in FIG. 12, it is assumed that close-up display area 420-30 determined for time t-30 which is an area determination time, and close-up display area 420-40 determined for time t-40, which is the next area determination time, do not overlap. Also, it is assumed that there is not a candidacy area enabling close-up display area 420 to be moved progressively from close-up display area 420-30 to close-up display area 420-40.

When an above rule is applied, smoothing interpolation determining section 340 temporarily reduces the size of close-up display area 420 between time t-30 and time t-40 until it disappears, and then enlarges it to its original size after changing its position.

As a result, as shown in FIG. 12, close-up display area 420-33 at time t-33 between times t-30 and t-40 is smaller than close-up display area 420-303. Then the position of close-up display area 420 moves, and close-up display area 420-34 at time t-34 immediately after the move overlaps the position of time t-40 close-up display area 420-40. Also, close-up display area 420-36 at time t-36 between times t-34 and t-40 is of a size intermediate between time t-34 close-up display area 420-34 and time t-40 close-up display area 420-40.

As shown in FIG. 12, between times t-30 and t-33, interpolation is performed using close-up display areas 420-31 and 420-32 of a size between close-up display areas 420-30 and 420-33. Also, between times t-34 and t-36, interpolation is performed by means of close-up display area 420-35 of a size between close-up display areas 420-34 and 420-36. In this way, the size of close-up display area 420 changes smoothly.

As described above, according to this embodiment an object placement area is discriminated from a basic image, enabling close-up display area 420 to be determined according to an object placement area of basic image 701. Also, an object placement area is discriminated for a specific object, and close-up display area 420 is determined so as not to overlap a determined object placement area, enabling a close-up image to be displayed without interfering with the display of an object, such as a character, for which it is wished to display the entire image without fail in a basic image. That is to say, a close-up image can be displayed in a state in which influence on a basic image is suppressed. Also, utilizing the advantage of computer graphics of not suffering image quality degradation when enlargement is performed, a CG animation image can be displayed that is shot using a plurality of camerawork variations and from a plurality of angles on a single screen, enabling a user to be provided with more expressive images.

Also, since close-up display area 420 is determined within image display area 410, the size of image display area 410 can be used unaltered. Therefore, both a basic image and a close-up image can be displayed more effectively. Specifically, for example, based on a CG image in which only whole-body actions of characters can be displayed such as shown in FIG. 7, it is possible to display a CG image in which the expression of each character can be clearly understood, and moreover whole-body actions of characters can also be displayed, such as shown in FIG. 10.

Furthermore, according to this embodiment, an animation scenario 600 description is analyzed, necessary image material is acquired from image material database 200, appropriate camerawork is determined, and a basic image and close-up image are generated. By this means, CG animation can be generated in line with the content of animation scenario 600, and above-described effective image display can be implemented with the generated CG animation. Also, the size and position of close-up display area 420 of a section between area determination times can be interpolated. By these means, close-up display area 420 changes can be performed smoothly, a CG animation image viewer can easily keep visual track of close-up display areas 420, and higher-quality image display can be implemented.

In the above-described embodiment, an object displayed in a basic image has been assumed to be subject to close-up display, but the present invention is not limited to this. For example, an object that is subject to close-up display may be an object that is not displayed in a basic image, or a close-up image may be provided as an image independent of a basic image. Also, a case has been described in which an image subject to display is a CG animation image, but it is also possible to apply the above-described technology to a live-action image. For example, a live-action image may be analyzed by means of known image analysis technology, a display area of a specific object such as a human being detected, and a close-up image displayed in an area other than the detected area.

The disclosure of Japanese Patent Application No. 2006-211336, filed on Aug. 2, 2006, including the specification, drawings and abstract, is incorporated herein by reference in its entirety.

### INDUSTRIAL APPLICABILITY

An image display apparatus and image display method according to the present invention are suitable for use as an image display apparatus and image display method that enable both a basic image and a close-up image to be displayed more effectively. In particular, an image display apparatus and image display method according to the present invention are suitable for use in a device with a small display screen, such as a mobile phone, PDA, portable game machine, or the like.

1. An image display apparatus comprising:
a display area discriminating section that discriminates a display area of a specific object in a basic image that is subject to display; and
a close-up area determining section that determines a display area of a close-up image in the basic image according to the display area of the specific object in the basic image.

2. The image display apparatus according to claim 1, further comprising an image display section that displays the basic image, wherein:
the specific object is an object to be displayed with priority among objects placed in the basic image; and
the close-up area determining section determines an area other than the display area of the specific object within the display area of the basic image according to the image display section to be a display area of the close-up image.

3. The image display apparatus according to claim 2, further comprising a close-up area control section that causes the close-up image to be displayed when the display area of the close-up image determined by the close-up area determining section has an area greater than or equal to a predetermined area.

4. The image display apparatus according to claim 3, further comprising a close-up image generating section that generates an image of a close-up of the specific object as the close-up image,
wherein the close-up area control section controls display of the close-up image in synchronization with action of the specific object.

5. The image display apparatus according to claim 2, wherein the basic image and the close-up image are computer graphics animation images in which a computer graphics object is placed.

6. The image display apparatus according to claim 5, further comprising:
a camerawork determining section that determines camerawork of the basic image from an animation scenario;
a basic image generating section that generates the basic image based on the animation scenario and the camerawork of the basic image determined by the camerawork determining section; and
a close-up image generating section that generates the close-up image from the animation scenario.

7. The image display apparatus according to claim 6, wherein:
the camerawork determining section determines camerawork of the close-up image from the animation scenario; and
the close-up image generating section generates the close-up image based on the camerawork of the close-up image determined by the camerawork determining section.

8. The image display apparatus according to claim 7, further comprising an image material database that stores image material necessary for generating the computer graphics animation image,
wherein the basic image generating section and the close-up image generating section each acquire necessary image material from the image material database and generate the computer graphics animation image.

9. The image display apparatus according to claim 2, further comprising a smoothing interpolation determining section that, in a section in which the display area of the close-up image determined by the close-up area determining section changes, performs interpolation of that change.

10. The image display apparatus according to claim 1, wherein the display area discriminating section dynamically discriminates a display area of the specific object in the basic image that is subject to display.

11. An image display method comprising:
a display area discriminating step of discriminating a display area of a specific object in a basic image that is subject to display; and
a close-up area determining step of determining a display area of a close-up image in the basic image according to the display area of the specific object in the basic image discriminated by the display area discriminating step.
